(19) United States
(12) Patent Application Publication
(10) Pub. No.: US 2022/0180152 A1
(43) Pub. Date: Jun. 9, 2022

(54) INFORMATION PROCESSING APPARATUS AND METHOD FOR ANALYZING ERRORS OF NEURAL NETWORK PROCESSING DEVICE THEREIN

(71) Applicant: Electronics and Telecommunications Research Institute, Daejeon (KR)

(72) Inventor: Mi Young LEE, Daejeon (KR)

(73) Assignee: Electronics and Telecommunications Research Institute, Daejeon (KR)

(21) Appl. No.: 17/545,472

(22) Filed: Dec. 8, 2021

(30) Foreign Application Priority Data
Dec. 9, 2020 (KR) 10-2020-0171513
Apr. 21, 2021 (KR) 10-2021-0051500

(51) Int. Cl. G06N 3/04; G06N 3/08

(52) U.S. Cl. CPC G06N 3/0454; G06N 3/08

(57) ABSTRACT

Disclosed is an operating method of a neural network processing device that communicates with an external memory device and executes a plurality of layers including obtaining layer information of the plurality of layers by analyzing a connection structure of the plurality of layers, generating an input address and an output address for a target layer based on the layer information, receiving expected input data and expected output data for the target layer, storing the expected input data at an input address area of the external memory device corresponding the input address, storing output result data at an output address area of the external memory device corresponding the output address by executing the target layer, comparing the output result data with the expected output data, and determining whether an error for the target layer occurs.

### CROSS-REFERENCE TO RELATED APPLICATIONS

This application claims priority under 35 U.S.C. § 119 to Korean Patent Application No. 10-2020-0171513 filed on Dec. 9, 2020 and Korean Patent Application No. 10-2021-0051500 filed on Apr. 21, 2021, in the Korean Intellectual Property Office, the disclosures of which are incorporated by reference herein in their entireties.

### BACKGROUND

Embodiments of the present disclosure described herein relate to an information processing technology, and more particularly, relate to an information processing apparatus and an error analysis method of a neural network processing device included therein.

Nowadays, a convolutional neural network (hereinafter referred to as “CNN”) is being actively researched as one deep neural network (DNN) technology that is a technology for image recognition. A neural network structure has excellent performance in various object recognition fields such as object recognition and handwriting recognition. In detail, the CNN provides very effective performance for object recognition.

As an efficient CNN structure is presented nowadays, the recognition rate using a neural network has almost reached a level recognition of a human. However, the CNN structure becomes complicated and a layer depth thereof is increasing. Accordingly, when neural network hardware is designed, and the neural network is executed by generating internal operating instructions, many errors may occur in a lower layer. At this time, to detect the errors, the computation from the first layer of the neural network causes a long debugging time.

### SUMMARY

Embodiments of the present disclosure provide an information processing apparatus that executes computation from an intermediate layer, which is to be debugged, for the purpose of reducing an error detection time, and an error analysis method of a neural network processing device included therein.

According to an embodiment, an operating method of a neural network processing device that communicates with an external memory device and executes a plurality of layers includes obtaining layer information of the plurality of layers by analyzing a connection structure of the plurality of layers, generating an input address and an output address for a target layer based on the layer information, receiving expected input data and expected output data for the target layer, storing the expected input data at an input address area of the external memory device corresponding the input address, storing output result data at an output address area of the external memory device corresponding the output address by executing the target layer, comparing the output result data with the expected output data, and determining whether an error for the target layer occurs. A storage space of the external memory device is smaller than a total size of data output from the plurality of layers.

In an embodiment, the layer information includes at least one of a layer name, an input data name, or an output data name for each of the plurality of layers.

In an embodiment, the generating of the input address and the output address includes receiving information about the target layer, detecting the target layer among the plurality of layers based on the information about the target layer, and computing the input address and the output address based on the layer information about the target layer.

In an embodiment, the expected input data and the expected output data are generated from a reference neural network model composed of the plurality of layers and are stored in an expected result database depending on the layer information.

In an embodiment, the storing of the expected input data includes matching the expected input data with the input address and storing the expected input data at the input address area of the external memory device in consideration of a size of the expected input data.

In an embodiment, the storing of the output result data includes performing a computation of the target layer based on the expected input data stored at the input address area and storing the output result data, which is an execution result of the computation, at the output address area.

In an embodiment, the comparing of the output result data with the expected output data includes determining whether a difference between the output result data and the expected output data is not less than a reference difference.

In an embodiment, the determining of whether the error for the target layer occurs includes determining that the error does not occur in the target layer, in response to the determination of whether the difference between the output result data and the expected output data is less than the reference difference and determining that the error occurs in the target layer, in response to the determination of whether the difference between the output result data and the expected output data is not less than the reference difference.

In an embodiment, the operating method of the neural network processing device further includes determining whether an error for each of one or more lower layers occurs, based on the layer information. The one or more lower layers are layers, an execution order of each of which is later than the target layer when the plurality of layers are executed sequentially, among the plurality of layers.

In an embodiment, the storage space of the external memory device is greater than a total size of data output from the target layer and the one or more lower layers.

According to an embodiment, an information processing apparatus includes a memory device and a neural network processing device that reads out expected input data for a target layer from the memory device, performs an error analysis operation through the target layer and lower layers of the target layer based on the expected input data, and stores pieces of output data according to the error analysis operation in the memory device. The neural network processing device includes a neural processor that outputs the pieces of output data by executing the target layer and the lower layers based on the expected input data, a processor that generates input addresses and output addresses for the target layer and the lower layers, and determines whether an error for the target layer and the lower layers occurs, by matching the expected input data with expected output data based on the input addresses and the output addresses, an internal memory that stores the input addresses and the output addresses, and a memory controller that stores the expected input data in the memory device based on each of the input addresses.

In an embodiment, the neural network processing device is composed of a plurality of layers including the target layer, the lower layers, and upper layers of the target layer. A storage space of the memory device is smaller than a total size of data output from the plurality of layers and is greater than a total size of data output from the target layer and the lower layers.

In an embodiment, the processor obtains layer information of the plurality of layers by analyzing a connection structure of the plurality of layers and generates the input addresses and the output addresses for the target layer and the lower layers based on the layer information.

In an embodiment, the processor receives the expected input data and the expected output data for the target layer and the lower layers from an expected result database and controls the memory controller so as to store the expected input data at each of the input addresses of the memory device.

In an embodiment, the processor controls the memory controller so as to read out output result data from each of the output addresses of the memory device and determines whether the error occurs for each of the target layer and the lower layers, by comparing the expected output data and the output result data.

### BRIEF DESCRIPTION OF THE FIGURES

The above and other objects and features of the present disclosure will become apparent by describing in detail embodiments thereof with reference to the accompanying drawings.

FIG. 1 is a block diagram of an information processing apparatus, according to an embodiment of the present disclosure.

FIG. 2 is a block diagram of a neural network processing device of FIG. 1.

FIGS. 3A and 3B are diagrams illustrating a neural network processing operation of a neural network processing device of FIG. 1.

FIG. 4 is a block diagram of an error management module of FIG. 2.

FIGS. 5A and 5B are flowcharts illustrating an error analysis operation of a neural network processing device, according to an embodiment of the present disclosure.

FIG. 6 is a diagram illustrating a specific embodiment of operation S130 of FIG. 5A.

FIGS. 7 and 8 are diagrams for describing a memory address generation operation and a memory area allocation operation of a neural network processing device, according to an embodiment of the present disclosure.

### DETAILED DESCRIPTION

Hereinafter, embodiments of the present disclosure will be described in detail and clearly to such an extent that an ordinary one in the art easily implements the present disclosure.

Moreover, function blocks used in the detailed description or drawings may be implemented with software, hardware, or a combination thereof in an embodiment of the present disclosure. The software may be a machine code, firmware, an embedded code, and application software. The hardware may be a circuit, a processor, a computer, an integrated circuit, integrated circuit cores, a pressure sensor, an inertial sensor, a microelectromechanical system (MEMS), passive elements, or a combination thereof.

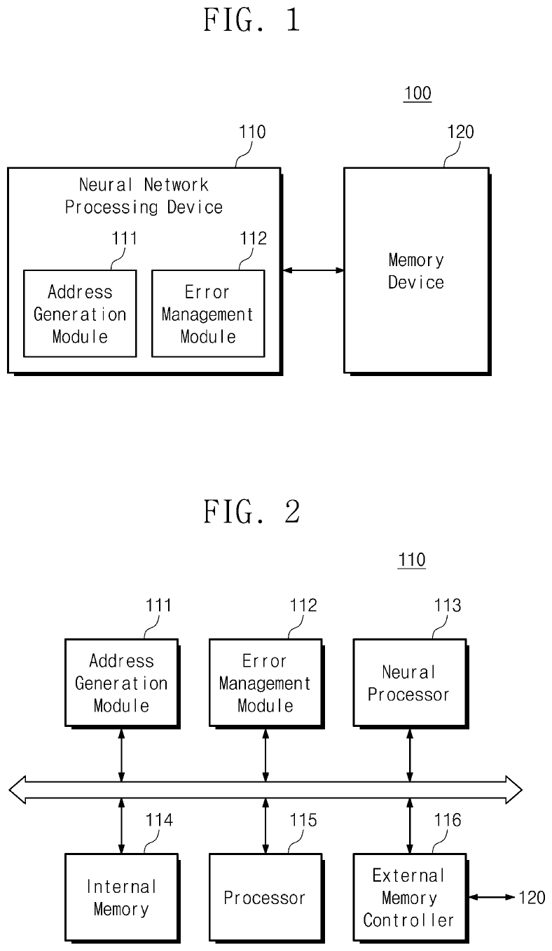

FIG. 1 is a block diagram of an information processing apparatus, according to an embodiment of the present disclosure. Referring to FIG. 1, an information processing apparatus 100 may include a neural network processing device 110 and a memory device 120. According to an embodiment, the information processing apparatus 100 may be one of various computing systems such as a personal computer, a notebook computer, a smartphone, a tablet PC, a digital camera, an electronic device of a vehicle, and the like.

The neural network processing device 110 may be configured to perform various neural network processing operations. For example, the neural network processing device 110 may identify data (e.g., object recognition, image classification, location recognition, or the like) from the outside based on various machine learning algorithms or artificial intelligence algorithms, such as CNN, DNN, and the like. According to an embodiment, the CNN may be trained for various purposes (e.g., general object recognition, location recognition, and the like) and may implement various purposes based on the trained model.

The memory device 120 may be configured to store data output from the neural network processing device 110 or to provide the stored data to the neural network processing device 110. For example, the memory device 120 may be one of a volatile memory, which loses data when power is cut off, such as DRAM, SRAM, or the like or a non-volatile memory, which holds data even when power is cut off, such as a flash memory, PRAM, ReRAM, MRAM, and FRAM.

According to an embodiment, the neural network processing device 110 may be configured to perform the above-described computation (i.e., a neural network computation) by sequentially processing a plurality of layers. For example, each of the plurality of layers may perform a predetermined computation on input data, and then may output a result of the computation as output data. The output data may be provided as input data of the next layer. Because the input data and the output data are used in the corresponding layer, the input data and the output data may be stored and managed in the memory device 120. In this case, because the structure of a neural network for computation may be diverse, the storage and management of the input data and output data need to be differently controlled depending on the structure of the neural network.

According to an embodiment, when the information processing apparatus 100 performs a neural network computation by using a memory device with a memory capacity of a specific size or more, the information processing apparatus 100 may allocate output results of all layers to different memory areas and may read and use the output results as necessary. However, it may be difficult for this method to be applied to the information processing apparatus 100 equipped with the memory device 120 having a limited memory capacity of less than a specific size. In this case, when an error occurs in an intermediate layer executing the neural network of the neural network processing device 110, analyzing the error by executing the neural network from the first layer to the intermediate layer, on which the error has occurred, needs to take a lot of time to analyze the error. In particular, when the depth of a neural network is great, this method may be inefficient.

According to an embodiment of the present disclosure, the neural network processing device 110 may analyze an error of a target layer by performing a computation from the target layer, which is expected to have an error, based on an address generation module 111 and an error management module 112. For example, the address generation module 111 may generate input addresses of pieces of input data used as an input of the target layer by analyzing the neural network connection structure. The error management module 112 may load expected input data onto an address area of the memory device 120 corresponding to the input address. The target layer of the neural network processing device 110 may perform a computation by loading the expected input data from the input address. The target layer of the neural network processing device 110 may perform error analysis by comparing the computed result with the expected result. According to an embodiment of the present disclosure, the address generation module 111 and the error management module 112 will be described in more detail with reference to the following drawings.

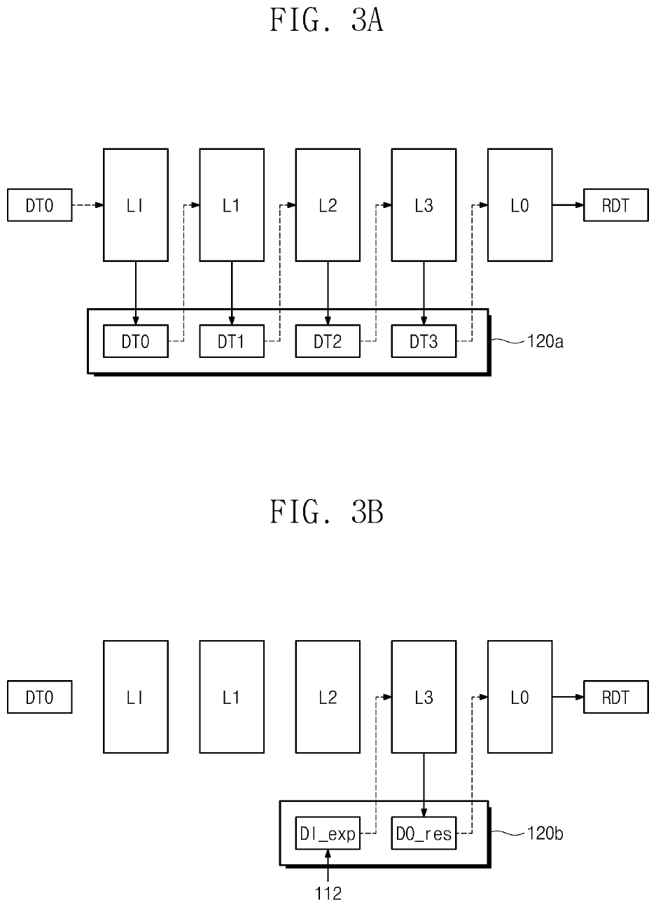

FIG. 2 is a block diagram of a neural network processing device of FIG. 1. Referring to FIGS. 1 and 2, the neural network processing device 110 may include the address generation module 111, the error management module 112, a neural processor 113, an internal memory 114, a processor 115, and an external memory controller 116.

The address generation module 111 may analyze a connection structure of a neural network and may generate an input address for the input data of the target layer and an output address for the output data of the target layer. According to an embodiment, the address generation module 111 may receive a structure file of the neural network and may obtain layer information about a plurality of layers executed by the neural processor 113 based on the structure file of the neural network. For example, the layer information may include a name of a layer, a name of input data of the layer, and a name of output data of the layer.

The address generation module 111 may receive information about the target layer and then may generate an input address for input data of the target layer and an output address for output data of the target layer based on the obtained layer information. For example, the information about the target layer may be a name of the target layer or a name of the input data of the target layer. According to an embodiment, the input data may be a frame, and the name of the input data may be a frame number. The address generation module 111 may detect the target layer corresponding to the received frame number.

The address generation module 111 may detect lower layers, each of which is lower than the target layer, based on the obtained layer information. The lower layers may be layers that are executed after the computation of the target layer is executed. For example, the neural network may include first to fourth layers and may output a result value as the first to fourth layers are sequentially executed. In this case, when the third layer is set as the target layer, the fourth layer may be a lower layer.

The address generation module 111 may obtain layer information about the target layer and lower layers and then may generate an input address and an output address for the target layer and input addresses and output addresses for the lower layers based on the layer information. Herein, the input address for a specific layer may indicate a location where input data to be input to a specific layer is stored in the storage space of the memory device 120. The output address for a specific layer may indicate a location where output data to be output from the specific layer is stored in the storage space of the memory device 120.

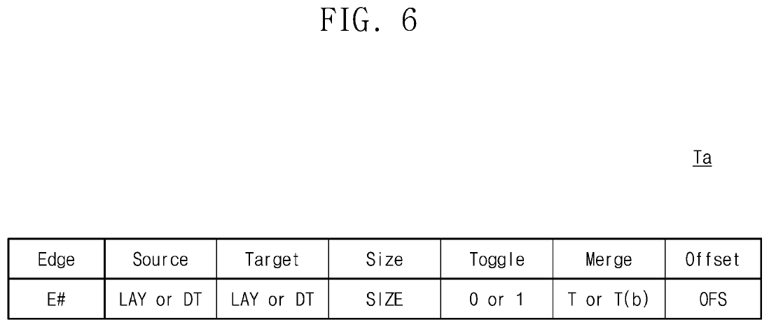

According to an embodiment, the address generation module 111 may generate the input address and the output address for the target layer and the input addresses and the output addresses for the lower layers through a memory management table managed based on the layer information. A detailed description of the memory management table will be described later with reference to FIG. 6. The input address and the output address for the target layer and the input addresses and the output addresses for the lower layers may be stored in the internal memory 114.

The error management module 112 may receive expected input data and expected output data for the target layer and expected input data and expected output data for the lower layers. The expected input data and the expected output data may be generated through a reference model for a neural network executed by the neural processor 113 and may be stored in an expected result database. The error management module 112 may store the expected input data and the expected output data in the memory device 120. In this case, the error management module 112 may store the expected input data and the expected output data in an address area of the memory device 120 corresponding to the input address and the output address for the target layer and the input addresses and the output addresses for the lower layers.

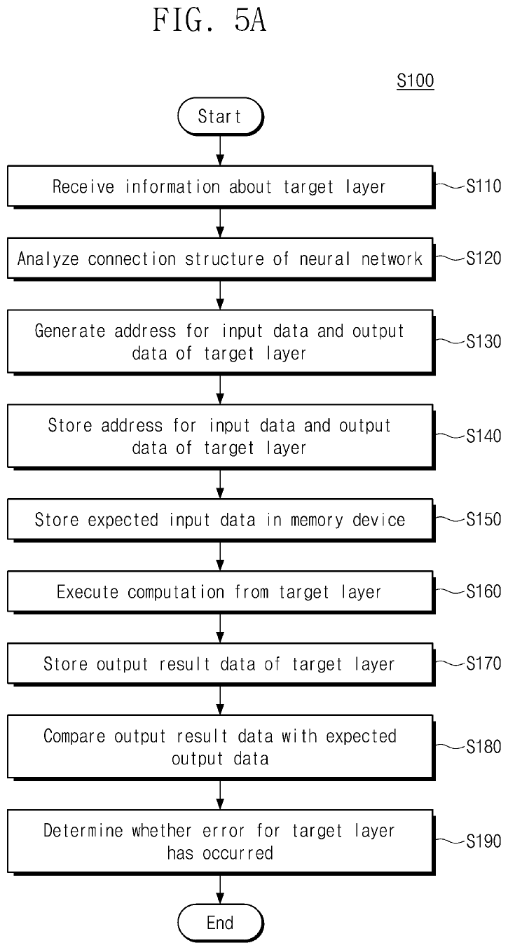

The error management module 112 may output error analysis result data by comparing the expected output data with the output result data executed by the neural processor 113. According to an embodiment, an operation of comparing the expected output data with the output result data may be performed by the neural processor 113 or the memory device 120. A detailed description of the error management module 112 will be described later in FIG. 4.

According to an embodiment, the address generation module 111 and the error management module 112 may be implemented in a software form, a hardware form, or a form of a combination thereof. The address generation module 111 and the error management module 112 in the software form may be stored in the internal memory 114. The program code or instructions stored in the internal memory 114 may be executed by the processor 115. That is, the processor 115 may be configured to perform operations of the address generation module 111 and the error management module 112.

The internal memory 114 may be used as a buffer memory or operating memory of the neural network processing device 110. The processor 115 may control overall operations of the neural network processing device 110.

The neural processor 113 may be configured to perform a computation operation performed on each of a plurality of layers. The neural processor 113 may receive the input address and the output address for the target layer and the input addresses and the output addresses for the lower layers from the internal memory 114. The neural processor 113 may execute a computation from the target layer based on the input address and the output address. The neural processor 113 may provide a result of the computation executed from the target layer to the memory device 120.

The external memory controller 116 may be configured to control the memory device 120. For example, on the basis of the input address computed by the address generation module 111, the external memory controller 116 may read out input data from the memory device 120 and may deliver the read input data to the neural processor 113. The neural processor 113 may generate output data by performing a neural network computation based on the received input data.

The external memory controller 116 may store the output data generated by the neural processor 113 to the external memory device 120 based on the output address computed by the address generation module 111.

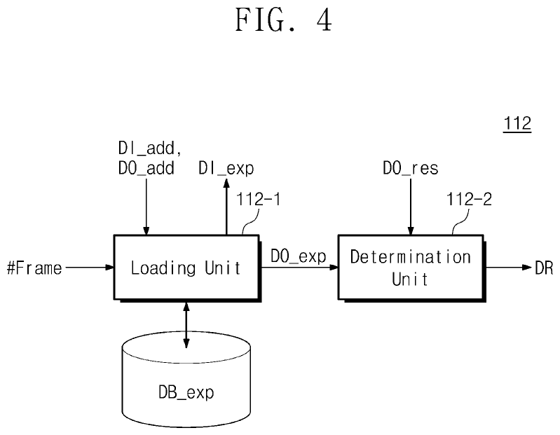

FIGS. 3A and 3B are diagrams illustrating a neural network processing operation of a neural network processing device of FIG. 1. To clearly describe an embodiment of the present disclosure, components unnecessary to perform a neural network processing operation of the neural network processing device 110 are omitted to avoid redundancy. Furthermore, in an embodiment of FIGS. 3A and 3B, the neural network processing operation of the neural network processing device 110 is shown briefly, but the scope of the present disclosure is not limited thereto. For example, the neural network processing device 110 may be configured to perform a computation according to a well-known neural network (in particular, CNN) such as Inception, ResNet, DenseNet, GoogleNet, VGG, or the like.

Referring to FIGS. 1 and 3A, the neural network processing device 110 may perform a neural network processing operation on input data DT0 and then may output output data RDT (or result data) as a result of the neural network processing operation. For example, when the neural network processing device 110 receives image information and classifies the received image information, the input data DT0 may be image data, and the output data RDT may be information about the classification result.

The neural network processing device 110 may perform the above-described neural network processing operation by sequentially performing a computation through a plurality of layers. For example, the plurality of layers of the neural network processing device 110 may include an input layer LI, first to third computation layers L1 to L3, and an output layer LO.

The input layer LI of the neural network processing device 110 may receive the input data DT0. The received input data DT0 may be stored in the external memory device 120a. The first computation layer L1 may receive the input data DT0 stored in a memory device 120a and then may output first data DT1 by performing a computation on the received input data DT0. The output first data DT1 may be stored in the memory device 120a.

The second computation layer L2 may receive the first input data DT1 stored in the memory device 120a and then may output second data DT2 by performing a computation on the received first input data DT1. The output second data DT2 may be stored in the memory device 120a.

The third computation layer L3 may receive the second input data DT2 stored in the memory device 120a and then may output third data DT3 by performing a computation on the received second input data DT2. The output third data DT3 may be stored in the memory device 120a.

The output layer L0 may receive the third data DT3 stored in the memory device 120a, and may output the received third data DT3 as the output data RDT.

As mentioned above, output data generated by each of the plurality of layers IL and L1 to L3 may be stored in the memory device 120a to be delivered to the next layer. That is, the storage space of the memory device 120a may be greater than a size of all of the output data generated by each of the plurality of layers IL and L1 to L3. In this case, for example, when an error occurs in the third computation layer L3, a layer in which an error has occurred may be detected by comparing the data DT0, DT1, DT2, and DT3 stored in the memory device 120a with the expected data.

On the other hand, referring to FIG. 3B, the storage space of a memory device 120b may be smaller than the size of all of the output data generated by each of the plurality of layers IL and L1 to L3. In this case, for example, when an error occurs in the third computation layer L3, a layer in which an error has occurred may be detected when output data is written and erased repeatedly in the memory device 120b while each of the plurality of layers IL and L1 to L3 is executed. However, because the neural network depth is great, this method is inefficient when the number of layers is great.

According to an embodiment of the present disclosure, the neural network processing device 110 may generate an input address and an output address for each of the input data and output data of the target layer based on information about the target layer (e.g., the third layer L3) and then may load expected input data DI_exp onto the input address of the memory device 120b to perform a computation from the target layer. Moreover, the neural network processing device 110 may obtain actual output result data D0_res of the target layer from the output address of the memory device 120b. The neural network processing device 110 may perform an error analysis operation by comparing the actual output result data D0_res with the expected output data. Accordingly, according to an embodiment of the present disclosure, the neural network processing device 110 may perform an efficient error analysis operation by using the memory device 120 having a limited size.

In an embodiment of FIG. 3B, some layers are shown, but the scope of the present disclosure is not limited thereto. For example, the neural network processing device 110 may perform a neural network processing operation and an error analysis operation through additional layers. Besides, in an embodiment of FIG. 3B, a configuration in which a plurality of layers are sequentially connected is illustrated, but the scope of the present disclosure is not limited thereto. For example, the plurality of layers may be connected in various ways.

FIG. 4 is a block diagram of an error management module of FIG. 2. Referring to FIGS. 1, 2, and 4, the error management module 112 may include a loading unit 112-1 and a determination unit 112-2. It is illustrated that the error management module 112 of FIG. 4 receives a frame number #Frame, which is a name of input data, as information about a target layer, but the scope of the present disclosure is not limited thereto.

The loading unit 112-1 may receive the frame number #Frame, an input address DI_add for the frame number #Frame, and an output address DO_add for the frame number #Frame. The target layer may be specified through the frame number #Frame. The input address DI_add for the frame number #Frame and the output address DO_add for the frame number #Frame may correspond to an input address for the target layer and an output address for the target layer. The input address DI_add for the frame number #Frame and the output address DO_add for the frame number #Frame may be received from the internal memory 114 as information generated by the address generation module 111 based on the frame number #Frame.

The loading unit 112-1 may receive expected input data DI_exp and expected result data DO_exp for the frame number #Frame from an expected result database DB_exp. The expected result database DB_xp may be a set of input data and output data for each layer, which are generated through a reference model for a neural network executed by the neural processor 113. For example, the input data and the output data for each layer may be stored depending on a frame number, and may be referred to as “expected input data” and “expected result data” of the present disclosure. In other words, the input data and output data according to the frame number #Frame generated through the reference model may be the expected input data DI_exp and the expected result data DO_exp for the frame number #Frame.

The loading unit 112-1 may match the expected input data DI_exp with the input address DI_add and may store the matched result in the memory device 120. Furthermore, the loading unit 112-1 may match the expected result data DO_exp with the output address DO_add and may provide the matched result to the determination unit 112-2. Afterward, when the neural processor 113 executes the target layer, the determination unit 112-2 may receive the output result data DO_res, which is actual output data, from the output address DO_add of the memory device 120 and may compare the output result data DO_res with the expected result data DO_exp.

The determination unit 112-2 may output determination result data DR, which is obtained by determining whether an error has occurred in the target layer, by comparing the expected result data DO_exp and the output result data DO_res. When a difference between the expected result data DO_exp and the output result data DO_res is less than a specific reference, the determination unit 112-2 may determine that an error has not occurred in the target layer. When the difference between the expected result data DO_exp and the output result data DO_res is not less than the specific reference, the determination unit 112-2 may determine that an error has occurred in the target layer.

According to an embodiment, the error management module 112 receives an input address and an output address for each of frame numbers lower than the received frame number #Frame and then may determine whether errors for the lower layers have occurred, based on expected input data and expected output data, which correspond to the input address and the output address.

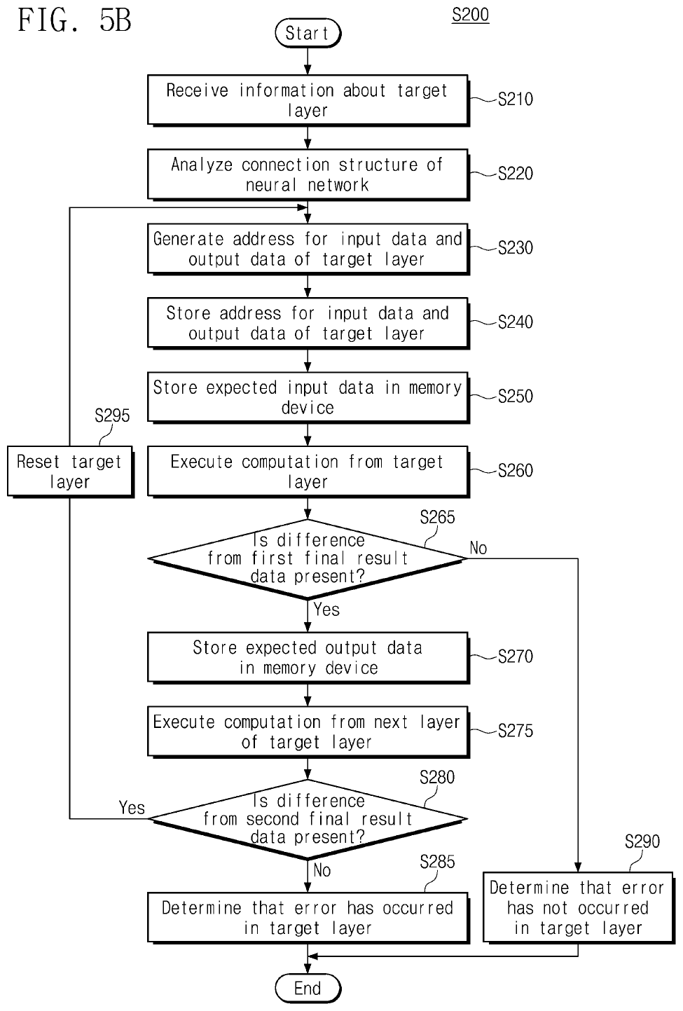

FIGS. 5A and 5B are flowcharts illustrating error analysis operations of a neural network processing device, according to an embodiment of the present disclosure. FIG. 5A and 5B illustrate different embodiments of an error analysis operation of the neural network processing device 110. The neural network processing device 110 of FIGS. 5A and 5B may communicate with the external memory device 120 and may execute a plurality of layers. Herein, the storage space of the memory device 120 may be smaller than the total size of data output from the plurality of layers.

Referring to FIGS. 1 and 5A, the neural network processing device 110 may perform an error analysis operation (S100) on a target layer by executing a computation from the target layer on which an error is to be analyzed.

In operation S110, the neural network processing device 110 may receive information about the target layer. For example, the information about the target layer may include at least one of a name of the target layer, an input data name of the target layer, or an output data name of the target layer. In operation S120, the neural network processing device 110 may obtain layer information of the plurality of layers by analyzing a connection structure of the plurality of layers. For example, the layer information may include at least one of a layer name, an input data name, or an output data name for each of the plurality of layers.

In operation S130, the neural network processing device 110 may generate an input address and an output address for the target layer based on the layer information. According to an embodiment, the neural network processing device 110 may receive the information about the target layer, and may detect the target layer from among the plurality of layers based on the information about the target layer. The neural network processing device 110 may compute an input address and an output address based on the layer information about the detected target layer. Together with the layer information, the size of data may be considered in a computation of input address and output address. According to an embodiment, a memory management table may be used.

In operation S140, the neural network processing device 110 may store an input address and an output address for the target layer generated in operation S130. For example, the input address and the output address may be stored in the internal memory 114. The input address for the target layer may indicate a location where input data to be input to the target layer is stored in the storage space of the memory device 120. The output address for the target layer may indicate a location where output data to be output from the target layer is stored in the storage space of the memory device 120.

In operation S150, the neural network processing device 110 may store expected input data for the target layer at the input address of the memory device 120. For example, the neural network processing device 110 may fetch the expected input data for the target layer from the expected result database, may match the expected input data with the input address, and may store the matched result. In this case, the size of the expected input data may be considered.

The size of the expected input data may need to be stored in the corresponding area of the memory device 120. The size of the expected input data may have a size that is great enough to store all pieces of output data of lower layers in the memory device 120 by executing a computation from the target layer. That is, the memory device 120 may have a size that is great enough to store all the pieces of output data of the lower layers as the target layer executes a computation based on the expected input data depending on the size of the expected input data.

According to an embodiment, the neural network processing device 110 may fetch the output expected data for the target layer from an expected result database. The output expected data may be compared with output result data, which is actual output data of the target layer.

In operation S160, the neural network processing device 110 may execute a computation from the target layer. For example, the neural processor 113 may receive the input address and the output address from the internal memory 114 and then may perform a computation for the target layer by using the expected input data stored at the input address of the memory device 120 as an input. In operation S170, the neural network processing device 110 may store the output result data, which is the result of computation, at the output address of the memory device 120.

In operation S180, the neural network processing device 110 may compare the output result data with the expected output data. For example, the neural network processing device 110 may fetch the output result data from the output address of the memory device 120 and may compare the output result data with the expected output data. The neural network processing device 110 may determine whether a difference between the output result data and the expected output data is not less than a reference difference. The reference difference may be a value stored in advance depending on the type of data. According to an embodiment, the neural network processing device 110 may determine whether the output result data is the same as the expected output data.

In operation S190, the neural network processing device 110 may determine whether an error has occurred in the target layer. The neural network processing device 110 may determine whether an error has occurred in the target layer, based on the comparison result determined in operation S180. For example, the neural network processing device 110 may determine that there is no error in the target layer, in response to the determination that the difference between the output result data and the expected output data is less than the reference difference. For example, the neural network processing device 110 may determine that an error has occurred in the target layer, in response to the determination that the difference between the output result data and the expected output data is not less than the reference difference.

According to an embodiment, the neural network processing device 110 may determine whether an error has occurred for each of the lower layers other than the target layer, based on layer information. The one or more lower layers may be present. The lower layer may indicate a layer of which the execution order is later than the target layer when a plurality of layers are executed sequentially. The neural network processing device 110 may generate an input address and an output address for each of one or more lower layers and may compare output result data, which is an actual output, based on the expected input data and the expected output data. Accordingly, the neural network processing device 110 may determine whether an error has occurred for each of the lower layers. In this case, the storage space of the memory device 120 may be smaller than the total size of data output from the plurality of layers, but may be greater than the total size of the data output from the target layer and one or more lower layers.

In other words, the neural network processing device 110 may analyze a connection structure of a plurality of layers and may compare the total size of output data of the target layer and lower layers with the size of the storage space of the memory device 120. Accordingly, the neural network processing device 110 may perform an error analysis operation depending on situations. When the number of lower layers is sufficient to store all of the output data of the target layer and lower layers in different areas of the memory device 120, the neural network processing device 110 may store all of the output data of the target layer and lower layers in the memory device 120 and then may compare the output data with the expected output data. Accordingly, the neural network processing device 110 may determine whether an error has occurred for each layer.

However, when the number of lower layers is not sufficient to store all of the output data of the target layer and lower layers in different areas of the memory device 120, the neural network processing device 110 may determine whether an error has occurred for each of the target layer and the lower layers while resetting the target layer. Hereinafter, the detailed description is given with reference to FIG. 5B.

Referring to FIGS. 1, 5A, and 5B, the neural network processing device 110 may perform an error analysis operation (S200). Operation S210, operation S220, operation S230, operation S240, operation S250, and operation S260 are similar to operation S110, operation S120, operation S130, operation S140, operation S150, and operation S160, and thus, additional description will be omitted to avoid redundancy.

In operation S210, the neural network processing device 110 may receive information about the target layer. In operation S220, the neural network processing device 110 may obtain layer information of the plurality of layers by analyzing a connection structure of the plurality of layers. In operation S230, the neural network processing device 110 may detect the target layer and may generate an input address and an output address for the target layer based on the layer information. In operation S240, the neural network processing device 110 may store an input address and an output address for the target layer generated in operation S230. In operation S250, the neural network processing device 110 may store expected input data for the target layer at the input address of the memory device 120.

In operation S260, the neural network processing device 110 may execute a computation from the target layer. The neural network processing device 110 may perform computations of entire lower layers, in addition to the target layer, and may output first final result data. That is, the first final result data may be data, which is output from a final lower layer, as a result of sequentially executing computations after the expected input data is entered into the target layer. In this case, the neural network processing device 110 may repeat memory creation and memory release based on a memory management table depending on a neural network connection relationship. Accordingly, the neural network processing device 110 may perform computations of the target layer and the lower layers by using minimal memory usage and then may output the first final result data.

In operation S265, the neural network processing device 110 may determine whether a difference is present, by comparing the first final result data with the expected result data. When there is no difference, in operation S290, the neural network processing device 110 may determine that an error has not occurred in the target layer and lower layers. When the difference is present, a procedure may proceed to operation S270.

In operation S270, the neural network processing device 110 may store the expected output data at the output address of the memory device 120. In a neural network structure thus sequentially executed, the expected output data for the target layer may be the same as the expected input data for the next lower layer of the target layer. That is, the expected output data stored at the output address of the memory device 120 may be input to the next lower layer of the target layer.

In operation S275, the neural network processing device 110 may execute a computation from the next lower layer of the target layer. The neural network processing device 110 may perform computations of all of the lower layers and then may output second final result data.

In operation S280, the neural network processing device 110 may determine whether a difference is present, by comparing the second final result data with the expected result data. When there is no difference, in operation S285, the neural network processing device 110 may determine that an error has occurred in the target layer. When the difference is present, in operation S295, the neural network processing device 110 may repeat from operation S230 by resetting the target layer.

As described above, error analysis operation 5200 of FIG. 5B may not analyze an error when an error occurs in both the target layer and the lower layer, but may be different from error analysis operation S100 of FIG. 5A in that an error is capable of being analyzed while memory capacity is minimized.

FIG. 6 is a diagram illustrating a specific embodiment of operation S130 of FIG. 5A. Referring to FIGS. 1, 5A, and 6, a memory management table Ta may include an edge field, a source field, a target field, a size field, a toggle field, a merge field, and an offset field. The memory management table Ta illustrated in FIG. 6 is an example for easily describing embodiments of the present disclosure. The scope of the present disclosure is not limited thereto.

The edge field may indicate information about an edge indicating a connection relationship between a plurality of layers. For example, as shown in FIG. 3A, first data DT1 may be output data for the first computation layer L1, and input data for the second computation layer L2. That is, it may be understood that the first and second computation layers L1 and L2 are connected to one edge. In other words, in an embodiment of the present disclosure, the edge may indicate a connection relationship (or a data sharing relationship) between specific layers, and the like.

The source field and the target field may be set to a layer name or a data name, respectively. In a process of computing an input address, the source field may be set as a layer name for a specific layer, and the target field may be set as the name of input data for a specific layer. In a process of computing an output address, the source field may be set as a name of the output data for a specific layer, and the target field may be set as a layer name for a specific layer.

The size field may indicate information about the size of data corresponding to the edge field.

The toggle field may indicate information for identifying an area of the memory device 120. For example, when the memory device 120 is used as a double buffer, the external memory device 120 may be divided into at least two independently accessible areas. In this case, a specific area to be accessed by the memory device 120 may be determined depending on the toggle field. According to an embodiment, the toggle field may be omitted depending on the driving method or structure of the memory device 120.

The merge information may be information for displaying edges, which are to be merged, from among a plurality of edges included in the memory management table Ta. A plurality of edges included in the memory management table Ta may be merged depending on the merge information.

The offset field may indicate information about an area that becomes blank by merging the plurality of edges.

The neural network processing device 110 may generate an input address and an output address for the target layer and input addresses and output addresses for the lower layers based on the memory management table Ta. For example, the neural network processing device 110 may compute an input address and an output address by using Equation 1.

ADDR[En]=Size: BF*TG+Sum[Size: E0˜n−1]+Sum[OFS:E0˜n−1] [Equation 1]

Referring to Equation 1, ADDR[En] denotes an address of the memory device 120 corresponding to an n-th edge. Size:BF denotes a size of a unit buffer of the memory device 120. TG may be a value of the toggle field corresponding to the n-th edge. SUM[Size:E0˜n−1] denotes the sum of sizes of the 0-th to (n−1)-th edges. SUM[OFS:E0˜n−1] denotes the sum of offsets of the 0-th to (n-1)-th edges. According to Equation 1 described above, the address of the memory device 120 corresponding to the n-th edge may be computed.

The neural network processing device 110 may receive information about the target layer and then may generate an input address and an output address for the target layer through Equation 1 based on the memory management table Ta. According to an embodiment, the input address and output address generated through Equation 1 may be generated by the address generation module 111 and then may be stored in the internal memory 114. The error management module 112 may receive an input address and an output address from the internal memory 114 and then may store the expected input data and the expected output data in the memory device 120 depending on the input address and the output address.

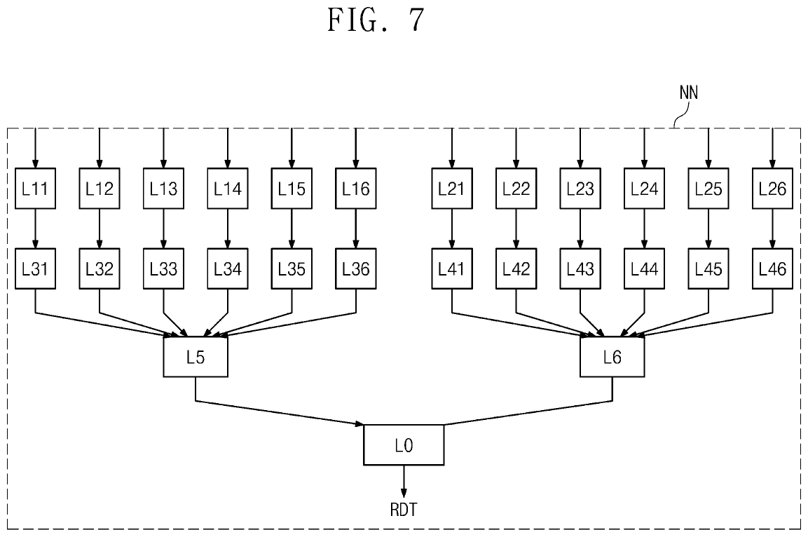

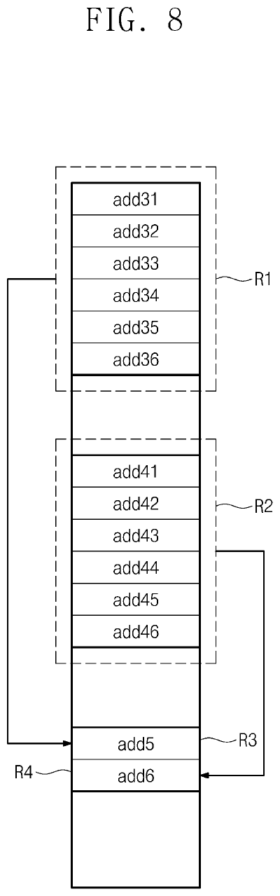

FIGS. 7 and 8 are diagrams for describing a memory address generation operation and a memory area allocation operation of a neural network processing device, according to an embodiment of the present disclosure. FIG. 7 is an example of a neural network connection structure of the neural network processing device 110. FIG. 8 is an example of an input address for a target layers and input addresses for lower layers.

Referring to FIGS. 1, 7, and 8, a neural network NN may include a plurality of layers. The plurality of layers may include first computation layers L11, L12, L13, L14, L15, and L16, second computation layers L21, L22, L23, L24, L25, and L26, third computation layers L31, L32, L33, L34, L35, and L36, fourth computation layers L41, L42, L43, L44, L45, and L46, a fifth computation layer L5, a sixth computation layer L6, and the output layer LO. For example, each of the plurality of layers may be a convolution layer, a pooling layer, a fully connected (FC) layer, or the like.

The first computation layers L11, L12, L13, L14, L15, and L16, the second computation layers L21, L22, L23, L24, L25, and L26, the third computation layers L31, L32, L33, L34, L35, and L36, the fourth computation layers L41, L42, L43, L44, L45, and L46, the fifth computation layer L5, the sixth computation layer L6, and the output layer LO may be performed sequentially. For convenience of description, the neural network NN may indicate a part of the entire neural network structure, and the present disclosure is not limited thereto.

According to an embodiment, the fifth computation layer L5 may be set as the target layer for error analysis. The neural network processing device 110 analyzes the connection structure of the neural network NN, and generates an input address and an output address for the fifth computation layer L5. For example, the input address and the output address may be generated based on the memory management table Ta of FIG. 6. The fifth computation layer L5 may be connected to the third computation layers L31, L32, L33, L34, L35, and L36.

The third computation layers L31, L32, L33, L34, L35, and L36 may store the output data in a first area R1 of the memory device 120. For example, the first area R1 may include third output addresses add31, add32, add33, add34, add35, and add36. Pieces of output data of the third computation layers L31, L32, L33, L34, L35, and L36 may be stored at the third output addresses add31, add32, add33, add34, add35, and add36, respectively. The output data of each of the third computation layers L31, L32, L33, L34, L35, and L36 may be input data of the fifth computation layer L5. That is, the third output addresses add31, add32, add33, add34, add35, and add36 may be input addresses for the fifth computation layer L5.

According to an embodiment, the neural network processing device 110 may generate an input address and an output address for the sixth computation layer L6 that is lower than the fifth computation layer L5. The sixth computation layer L6 may be connected to the fourth computation layers L41, L42, L43, L44, L45, and L46.

The fourth computation layers L41, L42, L43, L44, L45, and L46 may store the output data in a second area R2 of the memory device 120. For example, the second area R2 may include fourth output addresses add41, add42, add43, add44, add45, and add46. Pieces of output data of the fourth computation layers L41, L42, L43, L44, L45, and L46 may be stored in the fourth output addresses add41, add42, add43, add44, add45, and add46, respectively. The output data of each of the fourth computation layers L41, L42, L43, L44, L45, and L46 may be input data of the sixth computation layer L6. That is, the fourth output addresses add41, add42, add43, add44, add45, and add46 may be input addresses for the sixth computation layer L6.

According to an embodiment, the neural network processing device 110 may generate the third output addresses add31, add32, add33, add34, add35, and add36 and the fourth output addresses add41, add42, add43, add44, add45, and add46 and may store the expected input data. The fifth computation layer L5 and the sixth computation layer L6 may output output data by performing a computation operation based on expected input data.

The fifth computation layer L5 and the sixth computation layer L6 may store the output data in a third area R3 and a fourth area R4 of the memory device 120. For example, the third area R3 may include a fifth output address add5. The output data of the fifth computation layer L5 may be stored at the fifth output address add5. For example, the fourth area R4 may include a sixth output address add6. The output data of the sixth computation layer L6 may be stored at the sixth output address add6. That is, the fifth output address add5 and the sixth output address add6 may be output addresses for the fifth computation layer L5 and the sixth computation layer L6.

Output data of the fifth computation layer L5 and the sixth computation layer L6 may be used as input data of the output layer LO. The output layer LO may terminate a computation operation for the neural network NN by outputting the result data RDT based on the fifth computation layer L5 and the sixth computation layer L6.

According to an embodiment, the neural network processing device 110 may generate the fifth output address add5 and the sixth output address add6 and may receive output data of the fifth computation layer L5 and the sixth computation layer L6 from the fifth output address add5 and the sixth output address add6 of the memory device 120. The neural network processing device 110 may determine whether errors for the fifth computation layer L5 and the sixth computation layer L6 occurs, by comparing output data of the fifth computation layer L5 and the sixth computation layer L6 with expected output data.

The above description refers to embodiments for implementing the present disclosure. Embodiments in which a design is changed simply or which are easily changed may be included in the present disclosure as well as an embodiment described above. In addition, technologies that are easily changed and implemented by using the above embodiments may be included in the present disclosure. While the present disclosure has been described with reference to embodiments thereof, it will be apparent to those of ordinary skill in the art that various changes and modifications may be made thereto without departing from the spirit and scope of the present disclosure as set forth in the following claims.

According to an embodiment of the present disclosure, an information processing apparatus may execute computation from an intermediate layer, which analyzes an error, from among all layers of a neural network by analyzing a connection structure of a neural network, thereby reducing an error analysis time. Moreover, according to an embodiment of the present disclosure, an error analysis method may be applied to neural networks having various connection structures and may also be applied to an information processing apparatus having a limited memory capacity.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. An operating method of a neural network processing device configured to communicate with an external memory device and to execute a plurality of layers, the method comprising:
obtaining layer information of the plurality of layers by analyzing a connection structure of the plurality of layers;
generating an input address and an output address for a target layer based on the layer information;
receiving expected input data and expected output data for the target layer;
storing the expected input data at an input address area of the external memory device corresponding the input address;
storing output result data at an output address area of the external memory device corresponding the output address by executing the target layer;
comparing the output result data with the expected output data; and
determining whether an error for the target layer occurs,
wherein a storage space of the external memory device is smaller than a total size of data output from the plurality of layers.

2. The method of claim 1, wherein the layer information includes at least one of a layer name, an input data name, or an output data name for each of the plurality of layers.

3. The method of claim 2, wherein the generating of the input address and the output address includes:
receiving information about the target layer;
detecting the target layer among the plurality of layers based on the information about the target layer; and
computing the input address and the output address based on the layer information about the target layer.

4. The method of claim 1, wherein the expected input data and the expected output data are generated from a reference neural network model composed of the plurality of layers and are stored in an expected result database depending on the layer information.

5. The method of claim 4, wherein the storing of the expected input data includes:
matching the expected input data with the input address; and
storing the expected input data at the input address area of the external memory device in consideration of a size of the expected input data.

6. The method of claim 5, wherein the storing of the output result data includes:
performing a computation of the target layer based on the expected input data stored at the input address area; and
storing the output result data, which is an execution result of the computation, at the output address area.

7. The method of claim 1, wherein the comparing of the output result data with the expected output data includes:
determining whether a difference between the output result data and the expected output data is not less than a reference difference.

8. The method of claim 7, wherein the determining of whether the error for the target layer occurs includes:
determining that the error does not occur in the target layer, in response to the determination of whether the difference between the output result data and the expected output data is less than the reference difference; and
determining that the error occurs in the target layer, in response to the determination of whether the difference between the output result data and the expected output data is not less than the reference difference.

9. The method of claim 1, further comprising:
determining whether an error for each of one or more lower layers occurs, based on the layer information,
wherein the one or more lower layers are layers, an execution order of each of which is later than the target layer when the plurality of layers are executed sequentially, among the plurality of layers.

10. The method of claim 9, wherein the storage space of the external memory device is greater than a total size of data output from the target layer and the one or more lower layers.

11. An information processing apparatus comprising:
a memory device; and
a neural network processing device configured to:
read out expected input data for a target layer from the memory device;
perform an error analysis operation through the target layer and lower layers of the target layer based on the expected input data; and
store pieces of output data according to the error analysis operation in the memory device,
wherein the neural network processing device includes:
a neural processor configured to output the pieces of output data by executing the target layer and the lower layers based on the expected input data;
a processor configured to generate input addresses and output addresses for the target layer and the lower layers, and to determine whether an error for the target layer and the lower layers occurs, by matching the expected input data with expected output data based on the input addresses and the output addresses;
an internal memory configured to store the input addresses and the output addresses; and
a memory controller configured to store the expected input data in the memory device based on each of the input addresses.

12. The information processing apparatus of claim 11, wherein the neural network processing device is composed of a plurality of layers including the target layer, the lower layers, and upper layers of the target layer, and
wherein a storage space of the memory device is smaller than a total size of data output from the plurality of layers and is greater than a total size of data output from the target layer and the lower layers.

13. The information processing apparatus of claim 12, wherein the processor obtains layer information of the plurality of layers by analyzing a connection structure of the plurality of layers and generates the input addresses and the output addresses for the target layer and the lower layers based on the layer information.

14. The information processing apparatus of claim 13, wherein the processor receives the expected input data and the expected output data for the target layer and the lower layers from an expected result database and controls the memory controller so as to store the expected input data at each of the input addresses of the memory device.

15. The information processing apparatus of claim 14, wherein the processor controls the memory controller so as to read out output result data from each of the output addresses of the memory device and determines whether the error occurs for each of the target layer and the lower layers, by comparing the expected output data and the output result data.
